(19) United States
(12) Patent Application Publication
(10) Pub. No.: US 2025/0372996 A1
(43) Pub. Date: Dec. 4, 2025

(54) GRID PROTECTION APPARATUS AND METHOD

(71) Applicant: QBYSS Ltd, LONDON (GB)

(72) Inventor: LEE HARRISON, LONDON (GB)

(73) Assignee: QBYSS Ltd, LONDON (GB)

(21) Appl. No.: 18/874,320

(22) PCT Filed: Jun. 13, 2023
(86) PCT No.: PCT/GB2023/051534

§ 371 Date: Dec. 12, 2024

(30) Foreign Application Priority Data
Jun. 13, 2022 (GB) 2208642.5

(51) Int. Cl. H02H 1/00; H02H 1/04; H02H 5/00; H02H 7/04

(52) U.S. Cl. CPC H02H 1/0007; H02H 1/04; H02H 5/005; H02H 7/04

(57) ABSTRACT

A method of protecting a power transformer (101) in a power supply distribution grid (100) is described. The method comprises monitoring low frequency electrical signals in a circuit coupled to the power transformer (101) to provide a first detection signal (211); monitoring electromagnetic radiation to provide a second detection signal (212); in the event that the first detection signal (211) exceeds a first threshold, operating a protection switch (204a) connected to the transformer (101) to break the circuit and to reconnect the circuit in response to the first detection signal dropping below the first threshold; in the event that the second detection signal exceeds a second threshold, operating the protection switch (204a) to break the circuit at least until the first detection signal has dropped below the first threshold.

### FIELD OF INVENTION

The present invention relates to methods and apparatus and more particularly to an apparatus and method for protecting infrastructure, such as a transformer, in a power distribution grid, in particular, an apparatus and method are provided for protecting a power transformer in a power distribution grid from induced currents due to electromagnetic pulses (EMPs).

### BACKGROUND

The utility AC grid (e.g. a power distribution grid) is amongst the most complicated infrastructures on planet earth. Power distribution grids provide power to a large portion of electronic infrastructure, for example, transport systems, servers and computers for business and financial institutions and other infrastructure such as hospitals. Power distribution grids can be rendered non-functional by various external forces which are not protected against by current power distribution grids or routine maintenance and upgrades thereto. One such external force is a cyber-attack; cyber-attacks have temporarily rendered power distribution grids non-functional. Another external force which can render power distribution grids non-functional are electromagnetic pulse (EMP) events.

Sources of EMP events are solar storms and nuclear weapons or super EMP devices. For example, coronal mass ejections (CMEs) colliding with the Earth's magnetic field can generate high magnitude geomagnetic storms which have historically caused damage and outages to power distribution grids (e.g. the Carrington event in 1859). In today's highly dependent technology centric world, EMP events such as the Carrington event, would be devastating.

In addition to the threat posed by solar EMP we have to contend with the threat of more damaging EMP events from nuclear weapons, or super EMP devices. Any nuclear weapon detonated above an altitude of 30 kilometres will generate an EMP that will destroy electronics and could collapse the power distribution grid and other critical infrastructures, communications, transportation, banking and finance, food and water, essentials that sustain modern civilization and the lives of billions of people. The EMP threat extends beyond the local events. While a nuclear weapon detonated above a modern country could cause devastation, much smaller devices can use pulses of radio frequencies to damage specific targets such as, refineries, electric substations, power plants and other essential services.

Solar EMP events are generally categorised as E2 or E3 pulse events. Some known devices are designed to mitigate some of the risks of these events by way of filtering incoming supply lines.

However, the most damaging event is that of a weapon creating a very fast E1 pulse whereby the E2 and E3 pulses follow shortly afterwards. Fundamentally, protection from high altitude explosions (HEMP) is a demanding task and only more recently gaining momentum in protecting against such events. HEMP contains E1, a short single 2-25 nS pulse creating >55 kV/m at ground level, E2, similar to EMP delivered in lightning strikes and E3, a slower oscillating frequency, typically below 0.1 Hz and lower filed strength up to 100V/km which may last several minutes.

On initial assessment the E3 pulse appears of low frequency and relatively low field strength when compared to the high field strength on the E1 pulse. However, the E3 pulse can cause significant damage. Power lines connect to transformers on the grid, but the effect of the E3 pulse is such that geomagnetic induced quasi-DC currents will try to pass through the neutral conductor to earth, creating current that may exceed several hundred Amps. The danger of these large transformers saturating their core and therefore reducing their impedance will result in transformers heating up to the point whereby damage is almost certain.

A transformer with a saturated core generates powerful harmonics, in excess of the THD tolerances provided by the IEEE standards. These harmonics can cause protection devices and other equipment connected to the grid to misbehave, sometime irrecoverably.

A further complication to system performance occurs when the output from the grid drops quickly, this is due to the grid losing reactive power. In fact, geomagnetically induced currents caused by solar storms in Canada and the USA have resulted in transformers being damaged costing millions of dollars to replace. E3 pulses cause oscillations to be distributed along overhead power lines, often many miles long, but they end up essentially grounded via a low impedance loop.

There are a few devices in the industry designed to protect against such events, the most common being high voltage neutral blocking devices. While these are very expensive, they also require ample space at substation sites . . .

Therefore, a need exists to provide a smaller, lower cost alternative method of control during such events, with an enhanced detection of the E1 component of a weapon EMP to ensure the devices protected downstream never see the ensuing E2 or E3 events from a HEMP event.

### SUMMARY

Aspects of the invention are set out in the independent claims and optional features are set out in the dependent claims. Aspects of the disclosure may be provided in conjunction with each other and features of one aspect may be applied to other aspects.

An aspect of a method of protecting a power transformer in a power supply distribution grid, the method comprising: monitoring low frequency electrical signals in a circuit coupled to the power transformer to provide a first detection signal; monitoring high frequency electromagnetic fields to provide a second detection signal; in the event that the first detection signal exceeds a first threshold, operating a protection switch in the substation controlling the transformer to power down the high voltage circuits and to reconnect the circuit in response to the first detection signal dropping below the first threshold; in the event that the second detection signal exceeds a second threshold, operating the protection switch to power down the high voltage circuits at least until the second detection signal has dropped below the second threshold.

Note: Once a first or second detection has been triggered, multiple protection switches such as relays provide the user with the means to control elements of the substation during the event to prevent damage, such that when the event has passed the substation can resume normal operation.

The protection switch (e.g. a relay) may not be connected to a transformer, the protection switch(es) may provide protection by providing the means to turn off high voltage circuits and or control protection mechanisms in infrastructure such as a substation. For example they may be configured to shut down the power provision and/or power generation in the event that an EMP event is detected. The shutting off of these circuits may prevent the infrastructure (such as a transformer) being damaged by the EMP.

Advantageously, the method prevents saturation of a transformer core can be which can generate powerful harmonics which can damage the transformer and/or components electrically connected thereto.

Advantageously, the method protects a power transformer from all of the typical EMP pulses, namely, the E1, E2 and E3 pulses.

The circuit coupled to the power transformer may comprise a power distribution line of the power distribution grid. The power distribution line may be connected between the transformer and the power supply distribution grid. The power distribution line may be an AC neutral line of the transformer.

In examples, monitoring low frequency signals comprises sensing current. For example, monitoring low frequency signals comprises sensing a current between the AC neutral line and a ground voltage of the transformer. Note: For EMP this is sensing DC current in the neutral line

In examples, the low frequency signals comprise frequencies less than 0.5 Hz, for example less than 0.1 Hz.

The method may comprise monitoring high frequency electromagnetic fields detecting a change in conduction state of a PIN diode.

In examples, the high frequency electromagnetic comprise frequencies greater than 0.1 Hz.

In examples, in the event that the second detection signal exceeds the second threshold the protection switch is operated to break the circuit in a response time of less than 1 microsecond, for example less than 100 nanoseconds, for example less than 50 nanoseconds.

The protection switch may comprise a relay switch.

An aspect of the disclosure provides a grid protection apparatus configured to protect power distribution infrastructure of a power distribution grid from damage due to electromagnetic pulse, EMP, events, the apparatus comprising: a first detector configured to monitor low frequency electrical signals of the power distribution grid to provide a first detection signal; a second detector configured to monitor high frequency electromagnetic fields to provide a second detection signal; a controller configured to: operate a protection switch in the event that the first detection signal exceeds a first threshold, thereby to break a circuit to protect the power distribution infrastructure and subsequently to reconnect the circuit in response to the first detection signal dropping below the first threshold; and to operate the protection switch in the event that the second detection signal exceeds a second threshold and so that the circuit remains broken at least until the second detection signal has dropped below the second threshold.

Advantageously, an apparatus for protecting a power transformer may be provided which is cheaper than typical protection apparatus.

Advantageously, the method prevents saturation of a transformer core can be which can generate powerful harmonics which can damage the transformer and/or components electrically connected thereto.

Advantageously, the method protects a power transformer from all of the typical EMP pulses, namely, the E1, E2 and E3 pulses.

The first detector may be configured to monitor the low frequency electrical signals in a power distribution line of the power distribution grid. The power distribution line may be connected between the transformer and the power supply distribution grid. The power distribution line may be an AC neutral line of the transformer.

In examples, monitoring low frequency signals comprises sensing current with a current sensor. For example, the current comprises a current between an AC neutral line of the power distribution grid and a ground voltage.

In examples, the low frequency signals comprise frequencies less than 0.5 Hz, for example less than 0.1 Hz.

The second detector may be configured to monitor the high frequency electromagnetic fields based on detecting a change in conduction state of a PIN diode.

In examples, in the event that the second detection signal exceeds the second threshold the protection switch is operated to break the circuit in a response time of less than 1 microsecond, for example less than 100 nanoseconds, for example less than 50 nanoseconds.

The protection switch may comprise a relay switch. For example, the protection switches could be solid-state relays.

Any feature of any one of the examples disclosed herein may be combined with any selected features of any of the other examples described herein. For example, features of methods may be implemented in suitably configured hardware, and the configuration of the specific hardware described herein may be employed in methods implemented using other hardware.

### BRIEF DESCRIPTION OF THE DRAWINGS

Embodiments of the disclosure will now be described, by way of example only, with reference to the accompanying drawings, in which:

FIG. 1 illustrates a schematic view of a power distribution grid;

FIG. 2 illustrates a schematic view of a grid protection apparatus;

FIG. 3 illustrates a flowchart depicting a method of protecting a power transformer in a power supply distribution grid; and

FIG. 4 illustrates a gamma ray detector which may be used in a grid protection apparatus such as that described with reference to FIG. 2.

In the drawings like reference numerals indicate like elements.

### Specific Description

The present disclosure provides a method of protecting infrastructure, such as a transformer, in a power distribution grid and also provides a grid protection apparatus configured to protect such power distribution infrastructure from damage due to electromagnetic pulse (EMP) events. A brief description of parts of a typical power distribution grid will be given followed by a description of a grid protection apparatus according to the present disclosure. As will become clear, the disclosure is concerned with protection against both low frequency events, such as those associated with GIC, and rapid events such as those associated with NEMP.

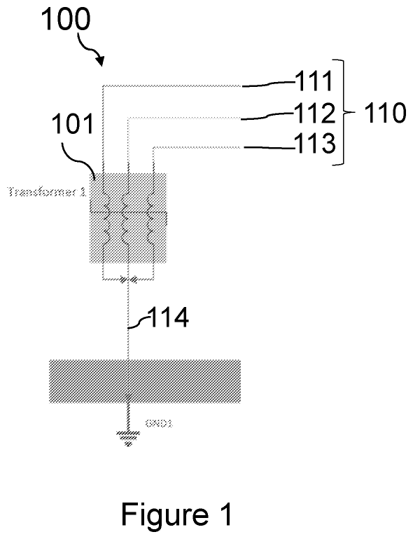

FIG. 1 illustrates a schematic view of power distribution grid 100. The power distribution grid 100 shown in FIG. 1 may be configured to distribute three-phase power, but the same disclosure may be applied to other types of power distribution. According to the present disclosure, in these and other power distribution grids, low frequency electrical signals are monitored in circuitry, such as power distribution lines 110 which may be coupled to a power transformer 101 e.g., producing DC currents in 114. In addition, gamma radiation dose rate is also monitored. In the event that the detection signal associated with the low frequency electrical signals (referred to herein as a “first detection signal”) exceeds a first threshold, a protection switch connected to the transformer is operated to break a circuit comprising the transformer and the power distribution line. Further, when this first detection signal drops again, the protection switch is operated to reconnect that circuit comprising the transformer 101 and the power distribution line 110. However, in the event that the monitoring of the gamma dose rate indicates an EMP event (e.g., when a second detection signal obtained from such monitoring exceeds a second threshold) the protection switch is operated to break the circuit, and the circuit is kept broken at least until the first detection signal (i.e., that associated with the low frequency electrical signals) has dropped below the first threshold. In an embodiment the low frequency monitoring (e.g., first detector 202 in FIG. 1) may monitor low frequency (e.g., DC) current in an AC neutral line, when this drops to normal levels (e.g. below a threshold) it is judged that the sensor the EMP event is over. This may be provided by a comparator monitoring a reflection of the DC current compared to an accurate voltage reference with some hysteresis to prevent bouncing switching. If the gamma detector is triggered then a timer is initiated and the protection switches (e.g. relays) are held open for at least a predetermined time, for example at least 100 mS.

FIG. 1 shows a transformer 101 as a three-phase transformer comprising three windings. Each of the windings carries a current with a different phase, namely: a first winding carries current of the first phase; a second winding carries current of the second phase (e.g. offset from the first phase by a phase of 120°); and a third winding carries current of the third phase (e.g. offset from the first phase by a phase of 240°). The power distribution line 110 comprises: a first line 111; a second line 112; and, a third line 113; and a neutral AC return line 114. The first line 111 is connected to the first winding of the transformer 101 and provides current with the first phase thereto. The second line 112 is connected to the second winding of the transformer 101 and provides current with the second phase thereto. The third line 113 is connected to the third winding of the transformer 101 and provides current with the third phase thereto.

The power distribution line 110 delivers current from a remote location to or from the transformer 101. For example the power distribution line may connect the transformer to a generator in a power station, or to consumer units in domestic and/or commercial premises.

The three windings of transformer 101 are connected to the AC neutral line 114. The AC neutral line 114 connects each of the three windings to ground.

The windings shown in FIG. 1 are arranged proximal to another set of windings (not shown) for the transfer of power therebetween. The other set of windings may be connected to a circuit comprising one or more components requiring power (e.g., appliances in domestic premises such as a house). In this manner, power can be delivered from a remote location (e.g., from a generator) to a destination where the power is required (e.g. an electrical appliance in a house). The power distribution grid comprises a plurality of these power distribution lines and transformers to distribute power from its point of generation to its point of use.

FIG. 1 also shows a grid protection apparatus which is configured to protect the power distribution infrastructure of a power distribution grid from damage due to electromagnetic pulse, EMP, events. This grid protection apparatus may operate as described above.

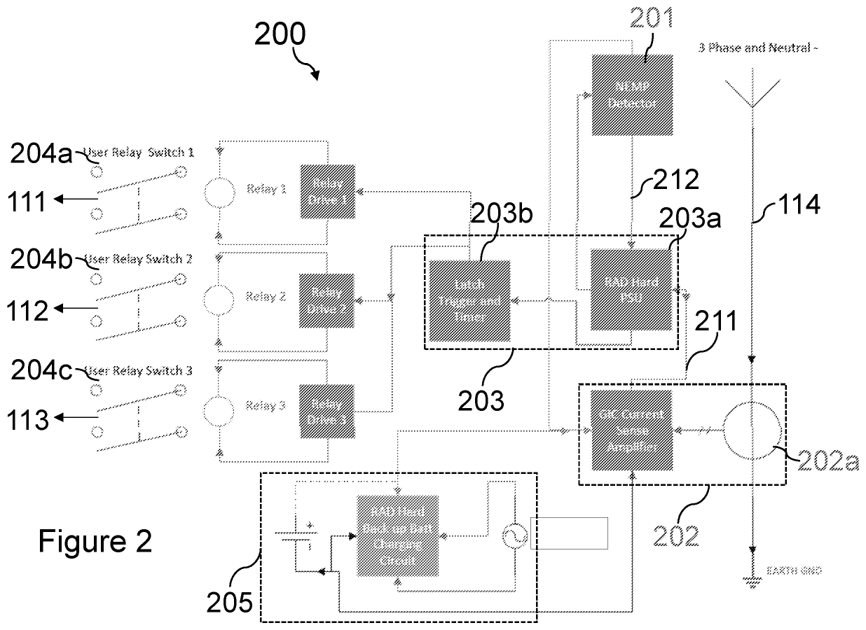

FIG. 2 illustrates a schematic view of one particular type of such grid protection apparatus 200. The grid protection apparatus 200 shown in FIG. 2 comprises: a first detector 202; a second detector 201; a controller 203; a first protection switch 204a; a second protection switch 204b; a third protection switch 204c; and, an auxiliary power supply 205.

The controller 203 is connected to the two detectors 201, 202, and to the protection switches 204a, 204b, 204c, and to the auxiliary power supply 205. The controller is configured so that, in the event that the first detector 202 indicates that low frequency electrical signals (such as those associated with GIC) exceed a first threshold, one or more of the protection switches are operated to break a circuit in the grid. Once the low frequency electrical signals drop below the threshold, the controller operates the protection switch to reconnect the circuit. In the event that the second detector 201 detects electromagnetic radiation (such as gamma radiation) having a dose rate greater than a second threshold, it operates the protection switch to break the circuit, and holds it open (e.g., for a predetermined period) to keep the circuit broken until the low frequency electrical signals have dropped away.

The first detector 202 is coupled to the neutral AC line 114 from the transformer (101; FIG. 1) for sensing current in the neutral AC line 114. The first detector 202 is connected to the controller 203 for providing a first detection signal 212 to the controller 203. For example, to sense current in the AC neutral line the first detector 202 may be clamped around the neutral AC line 114 (e.g., in the manner of a current clamp). This or other means may be used by the first detector 202 to sense, measure and communicate measured DC ground currents. The first detector 202 may also be connected directly to the protection switch circuits i.e. so that the second detection signal 212 provided by the second detector 201 is provided to the controller 203.

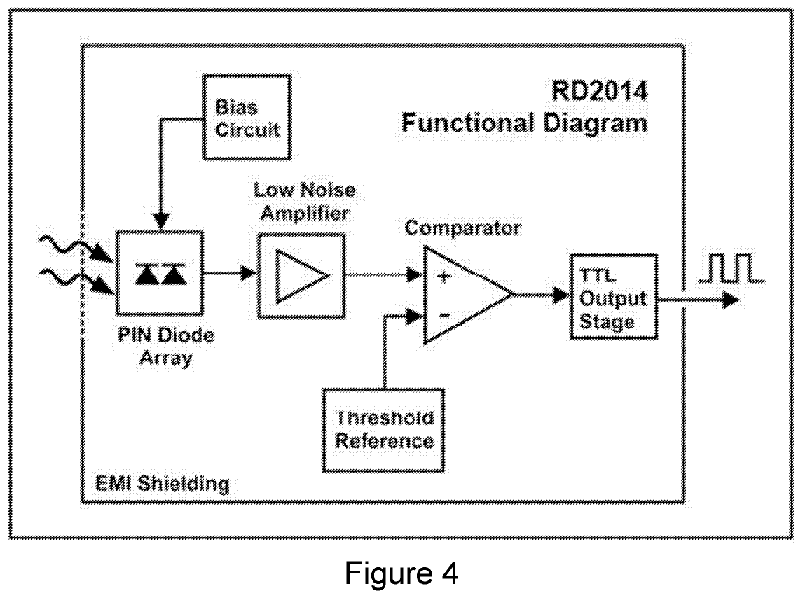

The second detector 201 is connected to the controller 203 and configured to monitor electromagnetic radiation, such as gamma radiation, of the type which may be associated with a nuclear or EMP weapon. On the basis of this monitoring the second detector 201 provides a second detection signal 211 to the controller 203. The second detector 201 is configured to respond to the fast burst of electromagnetic radiation (e.g., pulses of radiation with a period of 50 nS or less). The first detection signal 211 is thereby indicative of fast bursts of high frequency electromagnetic radiation, such as gamma radiation. An example of a gamma dose rate meter suitable for this purpose is described with reference to FIG. 4.

As illustrated in FIG. 4, the first detector 202 (NEMP detector) may comprise a PIN diode. The conduction state of the PIN diode changes in response to gamma radiation. The change in conduction state of the PIN diode is used to generate a first detection signal 212 indicative of the frequency of the high frequency electromagnetic fields.

The controller 203 may comprise a latch and trigger timer 203b and a radiation hardened power supply unit 203a. The radiation hardened power supply unit 203a may enable the controller to continue to operate after an EMP event, including an NEMP event. The latch and trigger timer, or other appropriate functionality of the controller is connected to a protection switch arrangement 204a, 204b, 204c, which may comprise a plurality of relay switches and/or relay switch controllers.

In addition, the grid protection apparatus may also comprise an energy source 205, such as a battery and a battery charging circuit, such as a radiation hardened battery charging circuit. This may be connected for charging the battery from power obtained from the distribution grid, and the battery may be arranged for providing power to the controller 203, the first detector 202 and the second detector 201.

Different types of protection circuit may be used. In the example illustrated in FIG. 2 a first protection switch 204a may form part of a circuit in the power distribution infrastructure, for example it may be connected to a winding of a transformer, such as the transformer 101 illustrated in FIG. 1. Accordingly, the controller 203 is operable to control the first protection switch 204a to switch between two states: an open state, which breaks the circuit comprising the switch 204a and a closed state, which completes that circuit. The other protection switches 204b, 204c operate identically and may be arranged to break circuits in a variety of situations. Typically, these switches are arranged so that when open they prevent currents from flowing during EMP events thereby to protect the power distribution infrastructure. For example, they may be arranged to prevent unwanted current surges and/or to prevent damage to the transformer (e.g., by saturation of the transformer core which can generate powerful harmonics which can damage the transformer and/or components electrically connected to the transformer).

Regardless of the type of protection circuit, in addition to being able to use the protection circuits to break circuits, the controller 203 is also configured to operate the protection switches 204a, 204b, 204c, to reconnect the circuit (e.g., the controller to put one or more of the protection switches 204a in the closed state) when conditions are met under which the power distribution infrastructure can be safely reconnected. For example, the controller 203 may be configured to operate the protection switched 204a, 204b, 204c to reconnect the power distribution circuit after a predetermined time period.

The relays may be arranged to disable voltage supplies, such as high voltage supplies in a substation. This may be done by disabling control lines, such as “enable” control lines in the substation. These may provide low-level signals for control of the substation. Even when the voltage supplies are disabled, EMP may still provide low frequency (e.g., DC) current in its neutral line due to the EMP, picked up by the grid overhead cables. As a result, the first detector 202 may derive power from the energy source 205 to continue monitoring while the relay switches are open. Although the transformer may see a DC current in the neutral line under these conditions it cannot saturate if the high voltage circuits have been shut down, so the transformer is saved. Additionally, the timer used for gamma detection can be brought into play.

The present disclosure provides a method of protecting a power transformer in a power supply distribution grid.

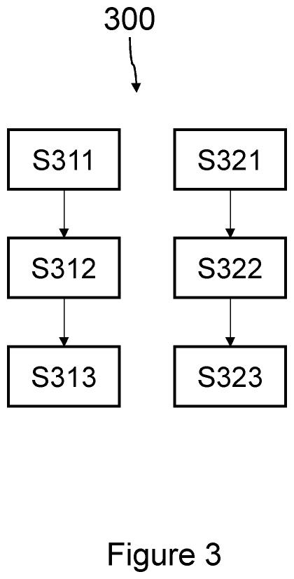

FIG. 3 illustrates a flowchart depicting a method 300 of protecting a power transformer in a power supply distribution grid. The method may be performed by a controller such as the controller 203 of FIG. 2.

The method 300 comprises the following steps:

The first detector 202 monitors, S311, low frequency electrical signals in a circuit coupled to the power transformer to provide a first detection signal. This is done by sensing low frequency (e.g. less than 0.5 Hz, for example less than 0.2 Hz) electrical signals in the circuit. For example, these currents can be sensed in an AC neutral line 114 coupled to the transformer 101. The first detector 202 generates a first detection signal 211 based on the sensed current. The first detection signal 211 is indicative of the low frequency electrical signals in the circuit. For example, the first detection signal may be indicative of the frequency and/or the magnitude of low frequency electrical signals detected by the first detector.

In the event that the first detection signal exceeds a first threshold, the one or more protection switches are operated, S312, to break the circuit.

Once the first detection signal falls back below the first threshold, the controller 203 may operate S313 the one or more protection switches to reconnect the circuit.

Concurrently with the monitoring S311 performed by the first detector, the second detector also monitors S321 electromagnetic radiation, such as gamma radiation, to provide a second detection signal to the controller. The second detector 201 may perform this monitoring in a variety of ways, but one such approach is described below with reference to FIG. 4.

In the event that the second detection signal exceeds a second threshold, the controller operates, S322, the one or more protection switches 204a, 204b, 204c to break the 20 circuit. The controller then operates switches 204a, 204b, 204c to reconnect S323, the circuit once both the low frequency signals sensed by the first detector and the electromagnetic radiation sensed by the second detector have both dropped below their respective thresholds.

In examples described herein it is preferable for the second detector 201 to detect pulses of radiation within a response time of less than 1 microsecond, for example less than 100 nanoseconds, for example less than 50 nanoseconds. The controller 205 may be configured for protecting circuits against E1 and/or E2 and/or E3 pulses. In this regard E1 pulses are characterised by a time period of approximately 10 nanoseconds 30 (e.g. a frequency of 20 MHZ) and a peak amplitude of approximately 50 kV/m. E2 pulses are characterised by a time period of 1 us to 10 ms (e.g. a frequency within the range of 100 Hz to 1 MHZ) and a peak amplitude of approximately 0.1 kV/m. E3 pulses are characterised by a time period of between 10 to 300 s (i.e. 10 seconds to 5 minutes) (e.g. a frequency of between 3.3 mHz to 0.1 Hz) and a peak amplitude of approximately 0.1 kV/m.

The controller may be configured to respond to detection of electromagnetic radiation (e.g. gamma) above the threshold dose rate by operating the relay switches in less than 50 nanoseconds and holding the protection switches open for at least a selected time period, e.g. long enough for the low frequency electrical signals detected by the first detector 202 to have decayed to a safe level, for example at least 1 minute, for example at least 5 minutes, for example at least 10 minutes.

It will be appreciated that method steps S311, S312, and S313 can be performed in parallel with (e.g., concurrently with) method steps S321, S322, and S323.

FIG. 4 illustrates a gamma detector which may be used as the second detector 201 in the examples discussed above. It will be appreciated in the context of the present disclosure however that a variety of different detector circuits may be used for detecting the gamma dose rate provided that the circuit is able to detect gamma dose rates of at least 1*103 Gy·s⁻¹ One example of a detector circuit is illustrated in FIG. 4. It can be seen that this circuit comprises a PIN diode. The detector circuit illustrated in FIG. 4 operates the pin diode in a forward biased state—e.g. at constant current. An amplifier may be connected to the pin diode for sensing the voltage across it. The arrival of radiation associated with an EMP triggers the generation of charge carriers in the depletion region of the PIN diode. This causes a change in the conduction state of the PIN diode and so a change in the voltage across it. Circuits of this type, and other such circuits, are suitable for providing detection signals quickly enough to meet the response time requirements of embodiments of the present disclosure.

Further embodiments are envisaged. It is to be understood that any feature described in relation to any one embodiment may be used alone, or in combination with other features described, and may also be used in combination with one or more features of any other of the embodiments, or any combination of any other of the embodiments. Furthermore, equivalents and modifications not described above may also be employed without departing from the scope of the invention, which is defined in the accompanying claims.

Where ranges are recited herein these are to be understood as disclosures of the limits of said range and any intermediate values between the two limits.

With reference to the drawings in general, it will be appreciated that schematic functional block diagrams are used to indicate functionality of systems and apparatus described herein. It will be appreciated however that the functionality need not be divided in this way and should not be taken to imply any particular structure of hardware other than that described and claimed below. The function of one or more of the elements shown in the drawings may be further subdivided, and/or distributed throughout apparatus of the disclosure. In some embodiments the function of one or more elements shown in the drawings may be integrated into a single functional unit.

In some examples the functionality of the controller may be provided by a general purpose processor, which may be configured to perform a method according to any one of those described herein. In some examples the controller may comprise digital logic, such as field programmable gate arrays, FPGA, application specific integrated circuits, ASIC, a digital signal processor, DSP, or by any other appropriate hardware. In some examples, one or more memory elements can store data and/or program instructions used to implement the operations described herein. Embodiments of the disclosure provide tangible, non-transitory storage media comprising program instructions operable to program a processor to perform any one or more of the methods described and/or claimed herein and/or to provide data processing apparatus as described and/or claimed herein. The controller may comprise an analogue control circuit which provides at least a part of this control functionality. An embodiment provides an analogue control circuit configured to perform any one or more of the methods and/or logic operations described herein.

The above embodiments are to be understood as illustrative examples. Further embodiments are envisaged. It is to be understood that any feature described in relation to any one embodiment may be used alone, or in combination with other features described, and may also be used in combination with one or more features of any other of the embodiments, or any combination of any other of the embodiments. Furthermore, equivalents and modifications not described above may also be employed without departing from the scope of the invention, which is defined in the accompanying claims.

These claims are to be interpreted with due regard for equivalents.

1-20. (canceled)

21. A method of protecting a power transformer in a power supply distribution grid, the method comprising:
monitoring low frequency electrical signals in a circuit coupled to the power transformer to provide a first detection signal;
monitoring electromagnetic radiation to provide a second detection signal;
in the event that the first detection signal exceeds a first threshold, operating a protection switch connected to the transformer to break the circuit and to reconnect the circuit in response to the first detection signal dropping below the first threshold;
in the event that the second detection signal exceeds a second threshold, operating the protection switch to break the circuit at least until the first detection signal has dropped below the first threshold.

22. The method of claim 21 wherein the circuit coupled to the power transformer comprises a power distribution line of the power distribution grid.

23. The method of claim 22 wherein the power distribution line is connected between the transformer and the power supply distribution grid.

24. The method of claim 22 wherein the power distribution line is an AC neutral line of the transformer.

25. The method of claim 21 wherein monitoring low frequency signals comprises sensing current.

26. The method of claim 25 wherein the current comprises a current between the AC neutral line and a ground voltage of the transformer.

27. The method of claim 21 wherein the low frequency signals comprise frequencies less than 0.5 Hz, for example less than 0.1 Hz

28. The method of claim 21 wherein monitoring electromagnetic radiation comprises detecting a change in conduction state of a PIN diode.

29. The method of claim 21 wherein the monitoring detects whether the electromagnetic radiation exceeds the second threshold in a response time of less than 1 microsecond, for example less than 100 nanoseconds, for example less than 50 nanoseconds.

30. The method of claim 21 wherein the protection switch comprises a relay switch.

31. A grid protection apparatus configured to protect power distribution infrastructure of a power distribution grid from damage due to electromagnetic pulse, EMP, events, the apparatus comprising:
a first detector configured to monitor low frequency electrical signals of the power distribution grid to provide a first detection signal;
a second detector configured to monitor electromagnetic radiation to provide a second detection signal;
a controller configured to:
operate a protection switch in the event that the first detection signal exceeds a first threshold, thereby to break a circuit to protect the power distribution infrastructure and subsequently to reconnect the circuit in response to the first detection signal dropping below the first threshold; and to
operate the protection switch in the event that the second detection signal exceeds a second threshold and so that the circuit remains broken at least until the first detection signal has dropped below the first threshold.

32. The grid protection apparatus of claim 31 wherein the first detector is configured to monitor the low frequency electrical signals in a power distribution line of the power distribution grid.

33. The grid protection apparatus of claim 32 wherein the power distribution line is connected between the transformer and the power supply distribution grid.

34. The grid protection apparatus of claim 32 wherein the power distribution line is an AC neutral line of the transformer.

35. The grid protection apparatus of claim 31 wherein monitoring low frequency signals comprises sensing current with a current sensor.

36. The grid protection apparatus of claim 35 wherein the current comprises a current between an AC neutral line of the power distribution grid and a ground voltage.

37. The grid protection apparatus of claim 31 wherein the low frequency signals comprise frequencies less than 0.5 Hz, for example less than 0.1 Hz

38. The grid protection apparatus of claim 31 wherein the second detector is configured to monitor the high frequency electromagnetic fields based on detecting a change in conduction state of a PIN diode.

39. The grid protection apparatus of claim 31 wherein the second detector is operable to determine whether electromagnetic radiation exceeds the second threshold in a response time of less than 1 microsecond, for example less than 100 nanoseconds, for example less than 50 nanoseconds.

40. The grid protection apparatus of claim 31 wherein the protection switch comprises a relay switch.
